(19) United States
(12) Patent Application Publication
(10) Pub. No.: US 2015/0242790 A1
(43) Pub. Date: Aug. 27, 2015

(54) SYSTEM AND METHOD FOR DESIGNING SERVICES USING VALUE QUADRANTS

(71) Applicant: Tata Consultancy Services Limited, Mumbai (IN)

(72) Inventors: Anand KUMAR, Pune (IN); Doji Samson LOKKU, Madhapur-Hyderabad (IN); Nikhil Ravindranath ZOPE, Mumbai (IN)

(21) Appl. No.: 14/633,373

(22) Filed: Feb. 27, 2015

(30) Foreign Application Priority Data
Feb. 27, 2014 (IN) 695/MUM/2014

(51) Int. Cl. G06Q 10/06

(52) U.S. Cl. CPC G06Q 10/06375

(57) ABSTRACT

Disclosed is a system of designing one or more services for realizing value to one or more stakeholders. A value requirements determination module determines value requirements pertaining to a service. A value carrier identification module identifies one or more value carriers associated to the service. The one or more value carriers may facilitate to deliver the value to the one or more stakeholders. A value proposition module creates a value proposition for the service based on the one or more value carriers. In one aspect, each value parameter may be executed by at least one stakeholder of the one or more stakeholders for realizing the value to the one or more stakeholders. A value realization module facilitates realization of the value to the one or more stakeholders based upon accomplishment of the plurality of value parameters.

### CROSS-REFERENCE To RELATED APPLICATIONS AND PRIORITY

The present application claims priority to Indian Patent Application No. 695/MUM/2014, filed on Feb. 27, 2014, the entirety of which is hereby incorporated by reference.

### TECHNICAL FIELD

The present disclosure in general relates to a field ofdesigning services. More particularly, the present disclosure relates to design the services by using value quadrants.

### BACKGROUND

Service industry faces lot of challenges in meeting varying customer demands formaintaining service quality. Also, in various competitive scenarios, service providers should regularly improve and update the services in order to improve the growth of the respective service. Unlike products, services are difficult to articulate and hence it gets difficult to identify and remove defects with respect to a particular service. Most of the times when services are complex in nature, it gets extremely difficult to maintain the quality of service so as it does not affect reputationof the service providers.

Although services are difficult to design, there exists variety of service designing methodologies. However, most of the available service design methodologies are implicitly product design methodologies and they require tweaking to apply in a servicing situation. In the presence of different fields, and large number of design elements and characteristics, designing of a desired service still remains a challenge.

Unlike products, services do not have a fixed architecture or fixed number of components that may be stored and used. This is because services are intangible and there is nothing to store. The characteristics and elements of services are directly proportional to pattern of consumption. In order to bring in improvement with respect to the service, all the unsatisfactory elements should be analyzed beforehand so that corrects preventive measures. Hence, pre-analysis of the service because of its intangible nature,remains a difficult task before the service is rendered.

While designing the service, it is necessary to define an appropriate mix of physical and non-physical components. The decision about the presence or absence of a specific component depends on various factors. These factors arise as responses to consumer's needs and constraint the way the interactions between the components can be established. They are always competing or conflicting and it is the designers' responsibility to establish dynamic equilibrium between the various factors and create the configuration which exhibits the desired properties in the service to be delivered.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods of designing one or more services for realizing value to one or more stakeholders and the concepts are further described below in the detailed description. This summary is not intended to identify essential features of the disclosure nor is it intended for use in determining or limiting the scope of the disclosure.

In one implementation, a system of designing one or more services for realizing value to one or more stakeholders is disclosed. In one aspect, the system may comprise a processor and a memory coupled to the processor. The processor may execute a plurality of modules present in the memory. The plurality of modules may comprise a value requirements determination module, a value carrier identification module, a value proposition module, and a value realization module. The value requirements determination module may determine value requirements pertaining to a service. The value requirements may be determined in order to determine a value expected by each of one or more stakeholders. The value carrier identification module may identify one or more value carriers associated to the service. The one or more value carriers may facilitate to deliver the value to the one or more stakeholders. The value proposition module may create a value proposition for the service based on the one or more value carriers. The value proposition may comprise a plurality of value parameters. In one aspect, each value parameter may be executed by at least one stakeholder of the one or more stakeholders for realizing the value to the one or more stakeholders. The value realization module may facilitate realization of the value to the one or more stakeholders based upon accomplishment of the plurality of value parameters.

In one implementation, a method of designing one or more services for realizing value to one or more stakeholders is disclosed. In order to realize the value to the one or more stakeholders, initially, value requirements pertaining to a service may be determined. The value requirements may be determined in order to determine a value expected by each of one or more stakeholders. Upon determining the value requirements, one or more value carriers may be identified associated to the service. The one or more value carriers may facilitate to deliver the value to the one or more stakeholders. After identifying the one or more value carriers, a value proposition may be created for the service based on the one or more value carriers. In one aspect, the value proposition may comprise a plurality of value parameters. In one aspect, each value parameter may be executed by at least one stakeholder of the one or more stakeholders for realizing the value to the one or more stakeholders. Subsequent to the creation of the value proposition, the value may be realized to the one or more stakeholders based upon accomplishment of the plurality of value parameters. In one aspect, the aforementioned method designing the one or more services for realizing the value to the one or more stakeholders is performed by using a processor using programmed instructions stored in a memory.

In yet another implementation, non-transitory computer readable medium embodying a program executable in a computing device of designing one or more services for realizing value to one or more stakeholders is disclosed. The program may comprise a program code for determining value requirements pertaining to a service, wherein the value requirements are determined in order to determine a value expected by each of one or more stakeholders. The program may comprise a program code for identifying one or more value carriers associated to the service, wherein the one or more value carriers facilitate to deliver the value to the one or more stakeholders. The program may comprise a program code for creating a value proposition for the service based on the one or more value carriers, wherein the value proposition comprises a plurality of value parameters, and wherein each value parameter is to be executed by at least one stakeholder of the one or more stakeholders for realizing the value to the one or more stakeholders. The program may comprise a program code for facilitating realization of the value to the one or more stakeholders based upon accomplishment of the plurality of value parameters.

### BRIEF DESCRIPTION OF DRAWINGS

The foregoing summary as well as detailed description of embodiments of the present disclosure is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

FIG. 1 illustrate value quadrants comprising a value understanding quadrant, a value carrier quadrant, a value proposition quadrant, and a value realization quadrant, in accordance with an embodiment on the disclosure.

FIG. 2 illustrates a network implementation of a system for designing one or more services for realizing value to one or more stakeholders, in accordance with an embodiment of the present disclosure.

FIG. 3 illustrates the system, in accordance with an embodiment of the present subject matter.

FIG. 4 illustrates a method for designing the one or more services for realizing the value to the one or more stakeholders, in accordance with an embodiment of the present disclosure.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

It may be understood that designing one or more services based on value understanding, value carrier, value proposition and value realization enables a service designer to look beyond requirements. It is based on identifying a set of concerns that the service designer needs to consider and address while delivering a value to stakeholders associated with the service. In order to deliver the value, the service designer should move from addressing requirements to delivering the value to the stakeholders, move from performing a series of activities to achieve quality pertaining to the service, concern itself with character of the service which is above and beyond its common use, understand what is beneficial to the stakeholders in tackling a specific serviceable situation, go beyond benefits and look at net-benefits to the stakeholders, and work towards delivering the net-benefits.

The present invention facilitates delivery of value to stakeholders. The present invention follows the approach of understanding the benefits expected by the stakeholders including service consumer, deriving the net benefits that the service should deliver (including benefits to the service provider) to various stakeholders, correlating the net benefits to the quality characteristics that the service must possess, developing service components that host the service quality characteristics, composing the service components as part of service delivery such that the value perceived is realized by the stakeholders. In essence each stakeholder,associated to the service, collectively performs activities that enable the stakeholders to realize the value from the service.

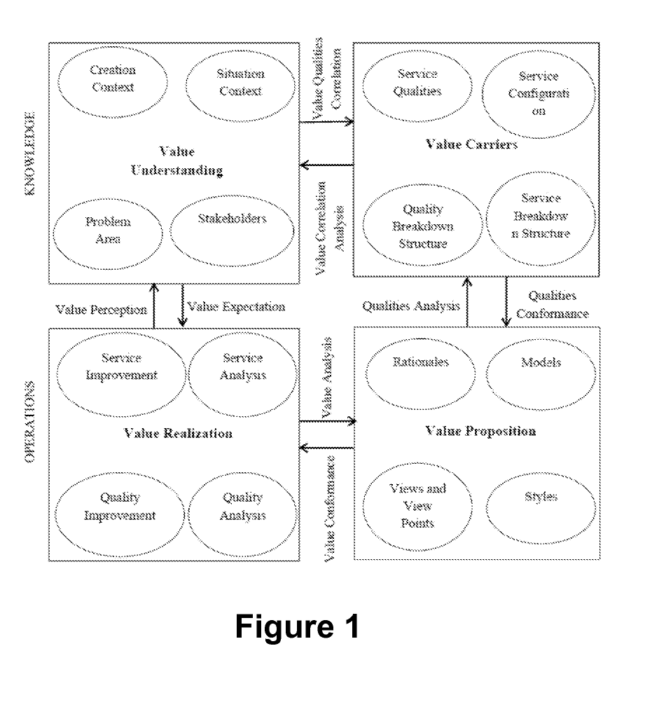

In order to realize the value, the present system(s) and method(s) design one or more services for realizing value to one or more stakeholders. The system and method utilizes one or more value parameters (or value quadrants) to design the one or more services. The one or more value parameters may comprise four quadrants as illustrated in FIG. 1. The one or more parameters may comprise value requirements obtained by understanding the serviceable situation, value carriers that are engineered into the service by the service providers, value proposition of the one or more services, and value realization for successfully designing the one or more services, development and delivery. It may be understood that the present system is configured to utilize the four quadrants to serve as an underlying theme for developing, describing and delivering services.

In one aspect, the value requirements, pertaining to the service, may be understood to determine the value expected by each stakeholder. Upon understanding the value requirements, the value carriers may be identified that facilitate value delivery to the stakeholders. Subsequently, the value proposition may be created for the service. In one aspect, the value proposition may comprise a plurality of value parameters wherein each value parameter may be executed by at least one stakeholder of the stakeholders for realizing the value to the one or more stakeholders. Based on the value proposition, the value may be realized to the stakeholders based upon accomplishment of the plurality of value parameters.

In order to realize the value, the present invention facilitates a service workbench functionality (service workbench functionality is described in detail as below) that provides packaging of service design tools, collaboration, coordination and networking, invocation and interoperation of service design tools, exchange of information between service design tools, and manipulation of information by various service design tools. Along with the service workbench functionality, the present invention further facilitates modelling functionality, model interpreter functionality, integration functionality, exchange server functionality, configuration functionality, decision support functionality, wizard functionality, and run-time functionality.

In one aspect, the modelling functionality provides information modelling, process modelling, value modelling, Graphical User Interface (GUI) modelling, presentation modelling, situation modelling, requirements modelling, and capability extension modelling. The model interpreter functionality provides process interpretation and execution, value identification and proposition, presentation interpretation and generation, requirements interpretation, data model interpretation, and GUI model interpretation. The integration functionality provides data integration, functionality or capability integration, features integration, and reports integration. The exchange server functionality provides information exchange between various tools,view point exchange, generating multiple views, ability to work on multiple views, and project information manipulated in a view on the unified information model. The configuration functionality provides capability configuration and process configuration. The decision support functionality provides decision analysis and decision formulation. The wizard functionality provides information gathering and process flow and sequencing. The run-time functionality provides common capabilities to the workbench and tools.

Service workbench functionality: Software architecture is the fundamental organizational scheme of the system relative to the purpose that the system is trying to accomplish. The service workbench is a schema of software components for achieving an architecture that enables service design problem formulation and resolution. In order to create the schema, it is necessary to identify a set of desired functional and non-functional quality characteristics and also to create an appropriate organization structure of software components that will deliver the quality characteristics. Some of the functional quality characteristics are defined below:
1. A meta-model and an instantiated model for the data schema. All service design information captured by the various tools is instances of this model.
2. An underlying collection of elemental data structures for information manipulation comprising attributes, value, methods and their collective identity.
3. A collection of components for information gathering comprising primitive GUI elements that are bounded to the elemental data structure.
4. A collection of process models for information transformation that specifies information and computation flow across the data structure instances.
5. A collection of components for information representation in the form of primitive reports or views or statistical analysis tools.
6. A collection of pluggable components for capability extensibility supporting standardized methods enumeration, parameter passing and invocation. These methods act on the information contained in the various data structures.
7. A run time to support composition of various service design tool components and information models.
8. A multi-modelling environment to capture different details of the system. There exist implicit inter-relationships between these models established by the runtime.

Some of the non-functional quality characteristics are:
1. Ability to handle different types of information models of existing service design tools and provision to handle models of future service design tools.
2. Ability to extend existing Graphical User Interface (GUI) elements to support new GUI elements. Ability to handle GUI requirements of various service design tools.
3. Ability to support service design processes of various service design tools. Ability to extend these process definitions to support new service design tools.
4. Drag and Drop, Point and Click capabilities to support information feeding and retrieval.
5. Model Interpreters should be scalable, extensible and should consume very less computing resources.

In one aspect, the goal of the service workbench is to support designers of the service in formulating and resolving their service design problem. Defining the service design problem involves discovering the problem, obtaining the requirements, arriving at solution fragments, defining solutions, creating service breakdown structure, developing the service blue print and identifying service processes that need to be executed.

In one embodiment, the system facilitates to create the service design workbench comprising a collection of service design tools. The service design workbench supports variability in processes, value, value carriers, GUI, data modelling, representation and functionality. The various service design tools that are realized support commonality by means of a run-time which binds the various model interpreters together. It may be understood that composition of the various service design tool components is implicit and built into the runtime. These components are designed, constructed and operated as an integral part of the system.

Multiple models are necessary which allows looking at different details of designing the service.

There exist implicit inter-relationships between these models which are established by the runtime.

Individual system characteristics are provided by the interpreter and its associated runtime and the interpreter and run-time are designed for a specific architecture.

In architecting the service design workbench, variability and commonality is possible in a few chosen dimensions only.

Thus, based on the aforementioned methodology and functionalities of the system as described, the one or more services may be designed for realizing the value to the one or more stakeholders.

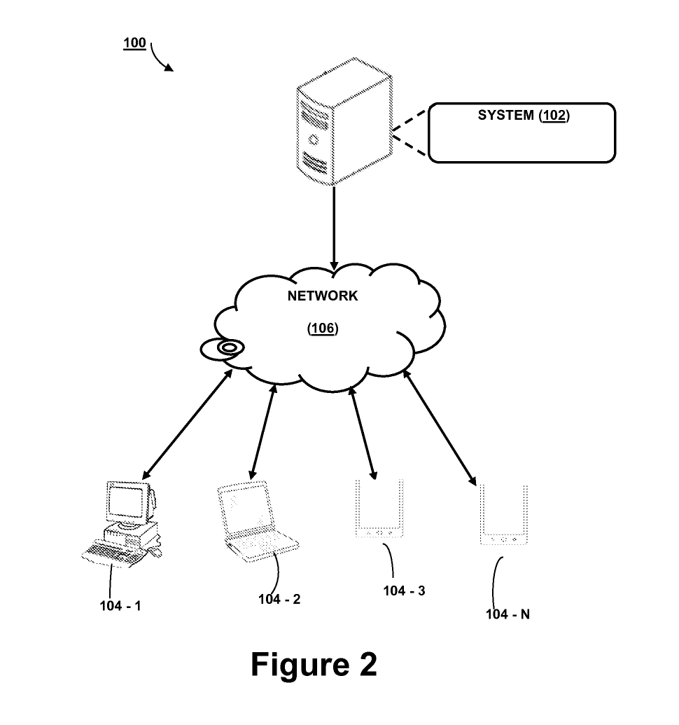

Referring now to FIG. 2, a network implementation 100 of a system 102 of designing one or more services for realizing value to one or more stakeholders. In order to realize the value to the one or more stakeholders, initially, the system 102 determines value requirements pertaining to a service. The value requirements may be determined in order to determine a value expected by each of one or more stakeholders. Upon determining the value requirements, the system 102 identifies one or more value carriers associated to the service. The one or more value carriers may facilitate to deliver the value to the one or more stakeholders. After identifying the one or more value carriers, the system 102 creates a value proposition for the service. In one aspect, the value proposition may comprise a plurality of value parameters. In one aspect, each value parameter may be executed by at least one stakeholder of the one or more stakeholders for realizing the value to the one or more stakeholders. Subsequent to the creation of the value proposition, the system 102 realizes the value to the one or more stakeholders based upon accomplishment of the plurality of value parameters.

Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment and the like. It will be understood that the system 102 may be accessed by multiple users through one or more user devices 104-1, 104-2 . . . 104-N, collectively referred to as user devices 104 hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

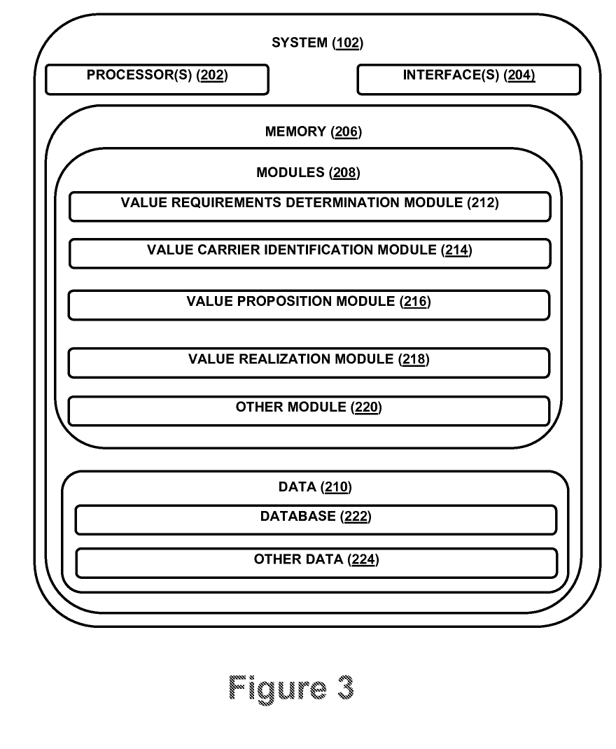

Referring now to FIG. 3, the system 102 is illustrated in accordance with an embodiment of the present disclosure. In one embodiment, the system 102 may include a processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208, other modules 210 and data 210.

The modules 208 include routines, programs, objects, components, data structures, etc., which perform particular tasks or implement particular abstract data types. In one implementation, the modules 208 may include a value requirements determination module 212, a value carrier identification module 214, a value proposition module 216, a value realization module 218, and other modules 218. The modules 208 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a database 220 and other data 222. The other data 222 may include data generated as a result of the execution of one or more modules in the other modules 218.

In one implementation, at first, a user may use the client devices 104 to access the system 102 via the I/O interface 204. The user may register themselves using the I/O interface 204 in order to use the system 102. In one aspect, the user may accesses the I/O interface 204 of the system 102 of designing one or more services for realizing value to one or more stakeholders. In one aspect, the value indicates a measure of worth (for example, benefit divided by cost) of a service provided to one or more stakeholders. In one aspect, the value may comprise on demand, on time delivery, increase effectiveness, productivity and throughput, within budget, no additional costs, less waste in terms of bottlenecks and inefficiencies, less business latency, experience certainty, reduce cost and enhance value. The measure of worth and the functions contributes significantly to the one or more stakeholders in terms of achieving their goals, plans, improvements, developments needed for growth are considered as appealing to the one or more stakeholder serves as the perceived possible value. The system 102 provides a comprehensive collaborative environment for realizing the value to the one or more stakeholders. Under the comprehensive collaborative environment, the system 102 is configured to utilize a value viewpoint approach that serves as the underlying theme for developing the one or more services, and delivering the one or more services.

It may be understood that the delivery of the one or more services involve the participation of many stakeholders in such a way that dictate and constraint the purpose and the design of the one or more services as a whole. Examples of the one or more stakeholders may include, but not limited to, provider side stakeholders, consumer stakeholders, and product marketing stakeholders. A service, of the one or more services, that has to be conceived needs perceptions and the measure of value which are often diverse and incompatible. In order to realize the value upon delivering the service, the system 102 determines insights pertaining to four different questions that need to be answered for the service to succeed economically. These four questions are:

What are the benefits and how to discover, diagnose and understand these benefits?

Insights: Anyone who gets affected by the service or participates in it in any way is a beneficiary. For the service to be beneficial to someone, it is necessary to figure out the benefits in terms of (1) usefulness in satisfying a consumer need, (2) relative importance of the need being satisfied, (3) availability relative to when it is needed, and (4) the cost of ownership. These economic considerations dictate consumer satisfaction and consumer's ability to satisfy their purposes.

What are the carriers for achieving these benefits? How can one derive these carriers of value?

Insights: For the service that fulfils the expectations in terms of delivering benefits, it should exhibit the appropriate service quality characteristics. The service quality characteristics determine how well the service delivery is able to create benefits and it defines how the service addresses a given scenario. In one aspect, quality attributes are generally considered important factors for obtaining the service of good quality. The quality attributes may include maintainability, portability, testability, traceability, correctness, and robustness.

What are the cumulative net benefits that should be delivered by the service?

Insights: Services Design deals with the design and delivery of the service. The process of creating the value proposition of the service that is to be delivered starts with understanding the quality characteristics, value creation context and specific situation; diagnosing it using archetypes, patterns and existing models; and synthesizing an approximate symbolic (or) mathematical (or) conceptual (or) physical representation. In summary, the value proposition is a multi-faceted artefact produced by the design process and composed of relatively independent and orthogonal facets of the service.

How does one compose and deliver a service so as to realize these benefits?

Insights:Essentially, the value proposition is used to create a plan of the service deliverables. It is used to verify and validate the various service components and their interconnections. This feedback is then used in the next iteration of the service design cycle, particularly when problems or challenges are identified. Service is the output that is created by the service delivery process which transforms design inputs to an acceptable output. It is characterized by the quality attributes that are of the value to the consumers. When this service is consumed, it creates the value to the consumers.

The insights obtained from answering the four different questions serve as four different interrelated perspectives as shown in the FIG. 1. Two perspectives focus on knowledge concerns, while other two focus on operational concerns. The two knowledge perspectives are ‘Value Understanding’ (Q1 in FIG. 1) and the ‘value carriers’ (Q2 in FIG. 1). The two operational perspectives, on the other hand, are the ‘Value Proposition’ (Q3 in FIG. 1) which is the specification of the value delivered by the service and ‘Value Realization’ (Q4 in FIG. 1) which is the instantiated design for the particular situation context. In combination, the four perspectives and their interrelationships provide a structure that enables the designer to comprehend the dynamics of the value based services design. In one aspect, the four perspectives address how the value to the one or more stakeholders is traced from value understanding; correlations to value carriers; specification as value propositions; and realization as a service.

In order to trace and realize the value, initially, the value requirements determination module 212 determines the value requirements pertaining to the service. In one aspect, the value may comprise on demand, on time delivery, increase effectiveness, productivity and throughput, within budget, no additional costs, less waste in terms of bottlenecks and inefficiencies, less business latency, experience certainty, reduce cost and enhance value. The value requirements may be determined in order to understand the value expected by each of one or more stakeholders. The value, expected by each stakeholder, is determined based on requirement of the one or more stakeholders, value creation processes of the one or more stakeholders, existing work process to deliver the value, and situation context. In one aspect, the value requirements may comprise identifying the one or more stakeholders, understanding stakeholder value creation context, understanding situation context, defining problem space, defining service space, and defining service value creation context.

Subsequent to the determination of the value requirements, the value carrier identification module 214 identifies one or more value carriers associated to the service. In one aspect, the one or more value carriers may be identified based on a service breakdown structure and a quality breakdown structure. The one or more value carriers may facilitate to deliver the value to the one or more stakeholders. In one aspect, once the value that needs to be delivered is determined, it is necessary to understand the means by which the value is delivered. In other words, all the value carriers that should exist in the service and contributes to the realization of the value to one or more stakeholders are considered as the quality of the service. In one aspect, the quality of the service is the degree to which the service satisfies the stated and implied needs of the one or more stakeholders, and thereby enables the value realization. The service quality is a function of (1) outcomes of the service delivery, (2) impact of the service on its stakeholders, (3) measure of the degree of satisfaction of consumer needs, (4) and measure of the capabilities of the service that benefits consumers. It measures the excellence of the service in a chosen dimension and is the basis for satisfying its stated purpose. In one aspect, the one or more value carriers may comprise redefining stakeholder value requirements, defining service configuration, defining service quality characteristics, correlating between value and quality, creating service breakdown structure, creating quality breakdown structure, and creating usage processes.

Subsequent to the identification of the one or more value carriers, the value proposition module 216 creates the value proposition for the service. In one aspect, the value proposition may be created based on the one or more value carriers. The value proposition may comprise a plurality of value parameters that include, but not limited to, identify design styles, define design rationales, define design models, create design views and viewpoints, translate to value proposition by creating appropriate service description, and qualities conformance. It may be understood that each value parameter may be executed by at least one stakeholder of the one or more stakeholders for realizing the value to the one or more stakeholders.

In one embodiment, the value proposition defines a collection of value objectives that needs to be realized by the service. The value objectives are achieved by careful organization of the service components, other elements of interest and other entities that needs to be delivered during the consumption of the service. In one aspect, this organization structure may include both structural and behavioural aspects, properties, service qualities, service elements, service components and their interrelationships. It may be understood that the value proposition may provide a general capability to express the service as a hierarchy of relevant value delivery structures.

After creating the value proposition, the value realization module 218 facilitates realization of the value to the one or more stakeholders based upon accomplishment of the plurality of value parameters. In one aspect, the value may be realized based upon instantiating the service for a specific instance and delivering the service, trace service description, analysis of the quality delivered against quality proposed, and analysis of the value delivered against desired value. Thus, in this manner, the present invention facilitates to design the one or more services for realizing the value to the one or more stakeholders.

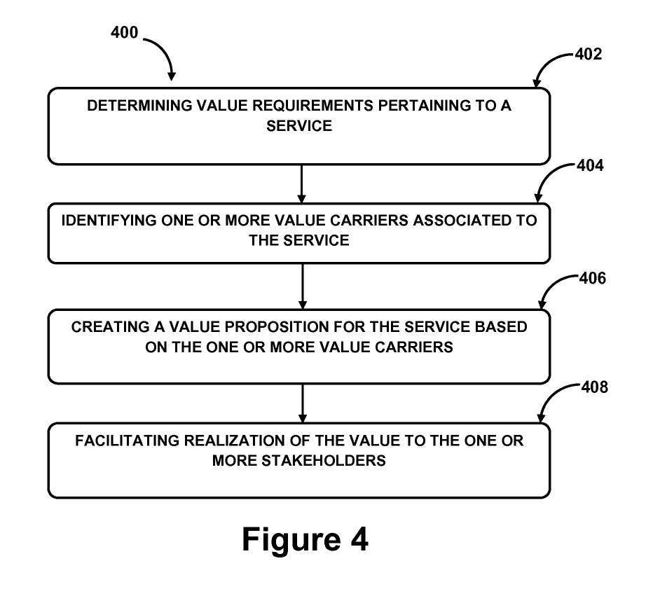

Referring now to FIG. 4, a method 400 of designing one or more services for realizing value to one or more stakeholders is shown, in accordance with an embodiment of the present disclosure. The method 400 may be described in the general context of computer executable instructions. Generally, computer executable instructions can include routines, programs, objects, components, data structures, procedures, modules, functions, etc., that perform particular functions or implement particular abstract data types. The method 400 may be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the disclosure described herein. Furthermore, the method can be implemented in any suitable hardware, software, firmware, or combination thereof. However, for ease of explanation, in the embodiments described below, the method 400 may be considered to be implemented in the above described in the system 102.

At block 402, value requirements pertaining to a service may be determined. In one aspect, the value requirements may be determined in order to determine a value expected by each of one or more stakeholders. In one implementation, the value requirements pertaining to the service may be determined by the value requirements determination module 212.

At block 404, one or more value carriers associated to the service may be identified. In one aspect, the one or more value carriers may facilitate to deliver the value to the one or more stakeholders. In one implementation, the one or more value carriers may be identified by the value carrier identification module 214.

At block 406, a value proposition for the service may be created based on the one or more value carriers. The value proposition may comprise a plurality of value parameters. In one aspect, each value parameter may be executed by at least one stakeholder of the one or more stakeholders for realizing the value to the one or more stakeholders. In one implementation, the value proposition may be created by the value proposition module 216.

At block 408, realizing the value to the one or more stakeholders based upon accomplishment of the plurality of value parameters. In one implementation, the value may be realized by the value realization module 218.

Although implementations for system and method of designing one or more services for realizing value to one or more stakeholdershave been described in language specific to structural features and/or methods, it is to be understood that the description are not necessarily limited to the specific features or methods described. Rather, the specific features and methods are disclosed as examples of implementations of designing the one or more services for realizing the value to the one or more stakeholders.

Exemplary embodiments discussed above may provide certain advantages. Though not required to practice aspects of the disclosure, these advantages may include those provided by the following features.

Some embodiments enable a system and a method to explicitly identify various stakeholders in the servicing scenario. The present disclosure also identifies all of those stakeholders who get affected by the service. The present disclosure facilitates complete understanding of requirements gathered from various stakeholders. The present disclosure understands value creation processes of stakeholders and how stakeholders perform their work processes to deliver outcomes.

Some embodiments enable a system and a method to accumulate knowledge of the problem domain and the serviceable situation based on processes by which provider stakeholders go about adding the value to their service customers. The present disclosure enables service delivery processes, stakeholders' responsibility satisfaction processes and associated management processes design such that service can deliver the value.

Some embodiments enable a system and a method to work out the underlying purpose of the service and agree upon the various service component abstractions. The present disclosure aids in analysing the situation context and work out a collection of feasible service concepts. The present disclosure aids in analysing service value creation processes and identify what value delivery is possible. The present disclosure aids in identifying the essential and distinguishing attributes that deliver the intended value. The present disclosure aids in prioritizing, delineating and segregating quality characteristics across different levels of understanding.

We claim:

1. A method of designing one or more services for realizing value to one or more stakeholders, the method comprising:
determining, using a processor, value requirements pertaining to a service, wherein the value requirements are determined in order to determine a value expected by each of one or more stakeholders;
identifying, using the processor, one or more value carriers associated to the service, wherein the one or more value carriers facilitates to deliver the value to the one or more stakeholders;
creating, using the processor, a value proposition for the service based on the one or more value carriers, wherein the value proposition comprises a plurality of value parameters, and wherein each value parameter is to be executed by at least one stakeholder of the one or more stakeholders for realizing the value to the one or more stakeholders; and
facilitating, using the processor, realization of the value to the one or more stakeholders based upon accomplishment of the plurality of value parameters.

2. The method of claim 1, wherein the one or more stakeholders are at least one of provider side stakeholders, consumer stakeholders, and product marketing stakeholders.

3. The method of claim 1, wherein the value comprises on demand, on time delivery, increase effectiveness, productivity and throughput, within budget, no additional costs, less waste in terms of bottlenecks and inefficiencies, less business latency, experience certainty,reduce cost and enhance value.

4. The method of claim 1, wherein the value, expected by each stakeholder, is determined based on requirement of the one or more stakeholders, value creation processes of the one or more stakeholders, existing work process to deliver the value, and situation context.

5. The method of claim 1, wherein the value requirements comprise identifying the one or more stakeholders, understanding stakeholder value creation context, understanding situation context, defining problem space, defining service space, and defining service value creation context.

6. The method of claim 1, wherein the one or more value carriers comprise redefining stakeholder value requirements, defining service configuration, defining service quality characteristics, correlating between value and quality, creating service breakdown structure, creating quality breakdown structure, and creating usage processes.

7. The method of claim 1, wherein the one or more value carriers are identified based on a service breakdown structure and a quality breakdown structure.

8. The method of claim 1, wherein the plurality of value parameters comprise identify design styles, define design rationales, define design models, create design views and viewpoints, translate to value proposition by creating appropriate service description, and qualities conformance.

9. The method of claim 1, wherein the value is further realized based upon instantiating the service for a specific instance and delivering the service, trace service description, analysis of the quality delivered against quality proposed, and analysis of the value delivered against desired value.

10. A system of designing one or more services for realizing value to one or more stakeholders, the system comprising:
a processor; and
a memory coupled to the processor, wherein the processor is capable of executing a plurality of modules stored in the memory, and wherein the plurality of modules comprising:
a value requirements determination module for determining value requirements pertaining to a service, wherein the value requirements are determined in order to determine a value expected by each of one or more stakeholders;
a value carrier identification module for identifying one or more value carriers associated to the service, wherein the one or more value carriers facilitate to deliver the value to the one or more stakeholders;
a value proposition module for creating a value proposition for the service based on the one or more value carriers, wherein the value proposition comprises a plurality of value parameters, and wherein each value parameter is to be executed by at least one stakeholder of the one or more stakeholders for realizing the value to the one or more stakeholders; and
a value realization module for facilitating realization of the value to the one or more stakeholders based upon accomplishment of the plurality of value parameters.

11. A non-transitory computer readable medium embodying a program executable in a computing device of designing one or more services for realizing value to one or more stakeholders, the program comprising a program code:
a program code for determining value requirements pertaining to a service, wherein the value requirements are determined in order to determine a value expected by each of one or more stakeholders;
a program code for identifying one or more value carriers associated to the service, wherein the one or more value carriers facilitate to deliver the value to the one or more stakeholders;
a program code for creating a value proposition for the service based on the one or more value carriers, wherein the value proposition comprises a plurality of value parameters, and wherein each value parameter is to be executed by at least one stakeholder of the one or more stakeholders for realizing the value to the one or more stakeholders; and
a program code for facilitating realization of the value to the one or more stakeholders based upon accomplishment of the plurality of value parameters.
